(19) United States
(12) Patent Application Publication
(10) Pub. No.: US 2023/0213477 A1
(43) Pub. Date: Jul. 6, 2023

(54) A Sensor System and a Method for Sensing Dielectric Particles of Biological Materials in Fluids

(71) Applicant: Technische Universität Braunschweig, Braunschweig (DE)

(72) Inventors: Annalena Eckert, Braunschweig (DE); Lea Könemund, Braunschweig (DE); Laurie Neumann, Braunschweig (DE); Felix Hirschberg, Braunschweig (DE); Rebekka Biedendieck, Braunschweig (DE); Aaron Bongartz, Braunschweig (DE); Wolfgang Kowalsky, Braunschweig (DE); Dieter Jahn, Wolfenbüttel (DE); Hans-Hermann Johannes, Braunschweig (DE)

(21) Appl. No.: 18/020,475

(22) PCT Filed: Aug. 17, 2021
(86) PCT No.: PCT/EP2021/072830

§ 371 Date: Feb. 9, 2023

(30) Foreign Application Priority Data
Aug. 17, 2020 (DE) 10 2020 121 574.6

(51) Int. Cl. G01N 27/447; B03C 5/00

(52) U.S. Cl. CPC G01N 27/4473; B03C 5/005; G01N 27/44743

(57) ABSTRACT

A sensor system for sensing dielectric particles of biological material in fluids is disclosed. The sensor system comprises a plurality of electrodes arranged on a substrate, and a dielectrophoretic device arranged on the substrate adjacent to one of the plurality of electrodes and a floating gate field effect transistor with a gate electrode connected to the dielectrophoretic device.

### CROSS-REFERENCE TO RELATED APPLICATIONS

This application is a national phase application based on PCT Patent Application No. PCT/EP2021/072830 filed on 17 Aug. 2021 and claims benefit of and priority to German Patent Application No 10 2020 121 574.6 filed on 17 Aug. 2020.

### BACKGROUND OF THE INVENTION

### Field of the Invention

The invention relates to a sensor system and a method for sensing dielectric particles of biological materials in fluids.

### Brief Description of the Related Art

Bacteria and other forms of biological material are found ubiquitously on earth and are central to major ecological processes. Almost all bacteria are harmless. However, there are a few pathogenic bacteria which are able to cause diseases in humans and animals. The analysis of microbial isolates and communities to determine the identity and quantity of the bacterial is currently time-consuming and requires expensive culture-dependent or molecular biology-dependent methods.

Identification and quantification methods for bacteria are important to medical diagnostics, to food and water safety control measures, and to basic and applied microbiological research. The classical methods for microbiological diagnostics mainly relied on the growth of known bacteria on a solid media for a long period of time, ranging from hours to days. We know now that 95% of bacteria cannot be cultured with these classical methods. Since approximately 25 years culture-independent, molecular biology-based methods have at least partly replaced the classical approach.

In addition to bacteria, many other types of biological material need to be identified and quantified. It is known that bacteria, as well as the other types of biological material have dielectric properties and therefore could in theory be identified using electronic means.

Electrowetting behavior of mercury and other liquids on variably charged surfaces was first explained by Gabriel Lippmann in a classic paper “Beziehungen zwischen den capillaren und elektrischen Erscheinungen”, Annalen der Physik und Chemie, 225, 546-561. doi:10.1002/andp.18732250807. Nowadays this phenomenon is applied in a wide field of applications ranging from μ-fluidics to camera lenses, large screen e-books, and displays.

In terms of biological material, electrowetting systems have been already reported. Firstly in 2004 Electrowetting-On-Dielectric (EWOD) principle was used for the preparation of biological samples, as taught by Belaubre, P., Guirardel, M., Leberre, V., Pourciel, J.-B., & Bergaud, C. (2004, 2), “Cantilever-based microsystem for contact and non-contact deposition of picoliter biological samples,” Sensors and Actuators A: Physical, 110, 130-135. doi:10.1016/j.sna.2003.09.024.

Since then the development of digital microfluidics in electrowetting platforms is utilized for different manipulation and analyzing processes. For example, Berthier et al., “Mechanical behavior of micro-drops in EWOD systems: drop extraction, division, motion and constraining” NSTI Nanotech 2005, NSTI Nanotechnology Conference and Trade Show, Anaheim, Calif., United States, May 8-12, 2005, described droplet based mechanical manipulations. The development of EWOD-microdevices for biological samples including DNA, proteins, and whole cells are under intense investigation and reveal promising applications. These digital microfluidic devices offer multiple possibilities as a lab-on-chip platform for preparation, manipulation, and analysis.

Dielectric particles in fluids, such as biological cells in a medium, are subjected to a force in a nonuniform alternating electric field depending on their dielectric properties. This phenomenon is called dielectrophoresis (DEP) (in contrast to the exposure of charged particles to a uniform constant electric field, named electrophoresis). Two types of DEP behavior are possible, depending on the geometry of the biological cells, the conductivity of the biological cells, the conductivity of the surrounding fluid or medium and the frequency and amplitude of the electric field. A negative DEP force (nDEP) repels the dielectric particles to a local minimum along the negative gradient of the electric field if the polarizability of the dielectric particles is less than the polarizability of the medium. Therefore, the nDEP force is generally used for continuous extraction of the biological cells under high conductivity liquid conditions.

A positive DEP force (pDEP) on the other hand attracts the biological particles to a local maximum along the positive gradient of the electric field if the polarizability of the biological materials is higher than that of the medium. In general, the pDEP force is used to attract the target cells to electrodes and then release the biological materials from the electrodes using a suspension buffer after the DEP force is removed, as described in Yoon, T., Moon, H.-S., Song, J.-W., Hyun, K.-A., & Jung, H.-I. (2019, 10), “Automatically Controlled Microfluidic System for Continuous Separation of Rare Bacteria from Blood,” Cytometry Part A, 95, 1135-1144.doi:10.1002/cyto.a.23909. A variation in the properties of the electric field, the geometry of the electrodes and the medium thus allows selective manipulation of the biological cells.

DEP is a technique commonly used in μ-fluidics for particle or cell separation and is considered a useful tool for manipulating cells prior to detection. Conventional microbiological methods are time consuming, mainly because they require several growth-based enrichment and separation steps. Compared to other separation methods, DEP has unique advantages such as being label-free, fast, and accurate and offers a possibility to concentrate cells without being restricted by bacterial growth. It has been widely applied in μ-fluidics for biomolecular diagnostics and in medical and polymer research (see Zhang, H., Chang, H., & Neuzil, P. (2019, 6), “DEP-on-a-Chip: Dielectrophoresis Applied to Microfluidic Platforms,” Micromachines, 10, 423. doi:10.3390/mi10060423.

An Electrolyte-Gated Organic Field-Effect Transistor (EGOFET) has been developed to detect the ion concentration of an electrolyte. Measuring results show an alteration of the electrical current in the organic semiconductor channel according to the ion concentration of the electrolyte.

The concept of a floating gate field-effect transistor (FG-FET) was developed for detecting purposes of bacteria and was described in publication by Thomas, M. S., White, S. P., Dorfman, K. D., & Frisbie, C. D. (2018, 3), “Interfacial Charge Contributions to Chemical Sensing by Electrolyte-Gated Transistors with Floating Gates,” The Journal of Physical Chemistry Letters, 9, 1335-1339. doi:10.1021/acs.jpclett.8b00285). Van der Spiegel et al. published first a concept which separates a sensor unit from the measuring unit (see Van Der Spiegel, J., Lauks, I., Chan, P., Babic, D. (1983), “The extended gate chemically sensitive field effect transistor as multi-species microprobe,” Sensor and Actuators, 4, 291-298.). Van der Spiegel documented a wire connection between sensor and the measuring unit.

A system for conducting quantitative, reverse transcription, polymerase chain reaction (qRT-PCR) on a micro-chip is described in a publication by Prakash, R.; Pabbaraju, K.; Wong, S.; Wong, A.; Tellier, R.; Kaler, K.V.I.S. “Multiplex, Quantitative, Reverse Transcription PCR Detection of Influenza Viruses Using Droplet Microfluidic Technology”. Micromachines 2015, 6, 63-79. https://doi.org/10.3390/mi6010063. The system of this publication uses a combination of electrostatic and electrowetting droplet actuation and is capable of sensing respiratory viruses, such as Influenza A and Influenza B.

A microchip-based system that is capable of both the extraction and purification of nucleic acids and the conduction of polymerase chain reaction (PCR) is described in a publication by Prakash, R., Pabbaraju, K., Wong, S. et al. “Integrated sample-to-detection chip for nucleic acid test assays”. Biomed Microdevices 18, 44 (2016). https://doi.org/10.1007/s10544-016-0069-8. The microchip-based system uses dielectrophoresis and electrostatic/electrowetting actuation. A droplet-dielectrophoresis (D-DEP) is used for passive, continuous and unidirectional transport of droplets. The dielectrophoresis and the electrostatic/electrowetting are sequentially arranged in the Prakash et al publication which allows droplet-manipulation before and after the dielectrophoresis. The dielectrophoresis is used for immobilizing, concentrating, and sorting of the particles.

An extended-gate type organic field-effect transistor (OFET)-based sensor system for sensing human immunoglobulin A (IgA) is described in a publication by Minamiki, T., Minami, T., Sasaki, Y., Kurita, R., Osamu, N. I., Wakida, & Tokito, S. (2015), “An Organic Field-effect Transistor with an Extended-gate Electrode Capable of Detecting Human Immunoglobulin A,” Analytical Sciences, 31, 725-728. doi:10.2116/analsci.31.725.

### SUMMARY OF THE INVENTION

This document teaches a sensor and a method which enables quantification, sorting, and characterization of biological materials, such as bacteria, unicellular, or other small cellular organisms, from different sources.

The method and sensor use a combination of electrowetting-based microfluidics in combination with a floating-gate field effect transistor and dielectrophoresis.

It is envisaged that the sensor and method will enable broad applications in medical diagnostics, food and water safety, agriculture, but also in basic microbiological research can be envisaged.

The sensor system for sensing dielectric particles of biological material in fluids comprises a plurality of electrodes arranged on a substrate and, in one aspect, a dielectrophoretic device arranged on the substrate adjacent to one of the plurality of electrodes. The sensor system further comprises at least one floating gate field effect transistor arranged on the substrate and wherein the dielectrophoretic device is connected to the gate electrode of the floating gate field effect transistor. The dielectric particles of biological material are, for example, bacteria, unicellular or other small cellular organisms.

The dielectrophoretic device can be directly or indirectly connected to the gate electrode of the field effect transistor.

The substrate has a hydrophobic coating to reduce the angle of contact between a surface of the substrate and drops of the fluids to enable the drops of the fluids to move about the substrate using electrowetting techniques. The substrate can have a structured surface to reduce the area of contact between drops of the fluid and the substrate. The electrodes can be arranged as an active matrix and can be independently switchable.

The system can be used in a method sensing dielectric particles of the biological materials in the fluid droplet with at least one other fluid droplet. In this case, the method comprises placing one or more of the fluid droplets with the dielectric particles on one or more of the plurality of electrodes, applying a potential to ones of the plurality of electrodes to move the fluid droplet with the dielectric particles from one of the plurality of electrodes to a dielectrophoretic device. The dielectrophoretic device can be connected to the gate electrode of the field effect transistor. The method can further comprise the steps of applying a potential to the dielectrophoretic device to immobilize the dielectric particles on the dielectrophoretic device and to sort or concentrate the dielectric particles and measuring the current through the channel of the field effect transistor.

The method can further comprise the step of changing a value or frequency of the potential applied to the dielectrophoretic device to sort different ones of the dielectric particles.

### BRIEF DESCRIPTION OF THE DRAWINGS

FIGS. 1A-1C show a sensor system for sensing dielectric particles of biological material in fluids.

FIG. 2 shows the method of operation of the sensor system.

FIG. 3 shows the mixing of fluid droplets.

FIGS. 4A and 4B show a floating gate FET.

FIG. 5 shows the measuring result of UV/V is spectroscopy of the first used modified porphyrin in solution (DMSO) and linked on a thin-film gold electrode.

FIGS. 6A and 6B show the transfer characteristic of the FG-FET gated with different suspensions on the sensor unit.

FIGS. 7A and 7B show schematics of the synthesized porphyrin structure.

FIG. 8 shows a simplified and exemplary arrangement of the dielectrophoretic electrodes.

FIGS. 9A and 9B show the transfer characteristic of the FG-FET with a different electrode-functionalization gated with different suspensions on the sensor unit.

FIG. 10 shows an equivalent circuit for testing the transfer characteristic of the FG-FET.

FIG. 11 shows a porphyrin structure according to FIGS. 7A and 7B with an exemplary peptide used for functionalizing the electrode of the FG-FET.

FIGS. 12A and 12B show the measuring results derived from images generated using fluorescent lifetime imaging microscopy of the functionalized surface of the electrode of the FG-FET.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

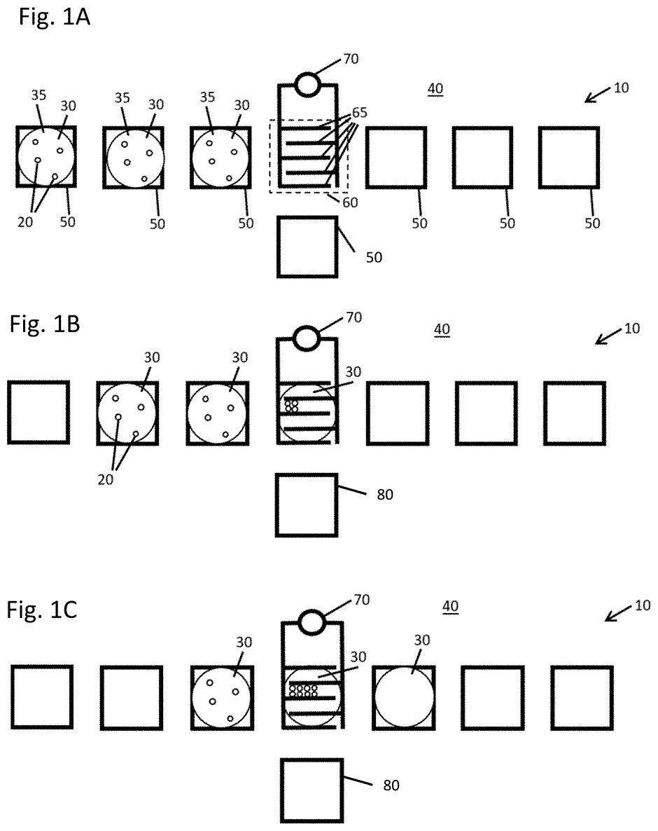

FIGS. 1A to 1C show a sensor system 10 for sensing dielectric particles 20 of biological material in fluids 30. The sensor system 10 comprises a plurality of electrodes 50 arranged on a substrate 40. A dielectrophoretic device 60 is arranged on the substrate 40 adjacent to and between two or more of the plurality of electrodes 50. One or more of the plurality of electrodes 50 shown in the FIGS. 1A to 1C can be replaced by floating gate field effect transistors. In a non-limiting example, a floating gate field effect transistor 80 is arranged on the substrate 40 below the dielectrophoretic device 60, and this is shown in FIGS. 1B and 1C. The gate electrode 85 (not shown in FIGS. 1A to 1C) of the floating gate field effect transistor 80 is connected to the dielectrophoretic device 60. The dielectrophoretic device 60 is connected to an AC voltage source 70 and has a plurality of dielectrophoretic electrodes 65 arranged in an interdigital alternate manner as shown in FIGS. 1A to 1C. The AC voltage source can generate voltages with frequencies of up to, for example, 100 MHz and peak voltages of up to 15V. These values are not limiting of the invention.

The dielectrophoretic electrodes 65 are made, for example of transparent indium tin oxide, but this is not limiting of the invention and other materials can be used. The arrangement of the dielectrophoretic electrodes 65 shown in FIG. 1 is also not however limiting of the invention. Indeed, the dielectrophoretic electrodes 65 with a curved shape are likely to be better at collecting the dielectric particles 20. The plurality of electrodes 50 are also connected to a switchable or pulsed voltage source which is not shown on FIGS. 1A to 1C for reasons of simplicity. Ones of the plurality of electrodes 50 can be individually turned on or off to move droplets of fluids from one of the plurality of electrodes 50 to another one of the plurality of the electrodes, as will now be explained. The size of the electrodes 50 is dependent on the size of the drop and the geometry of the electrodes.

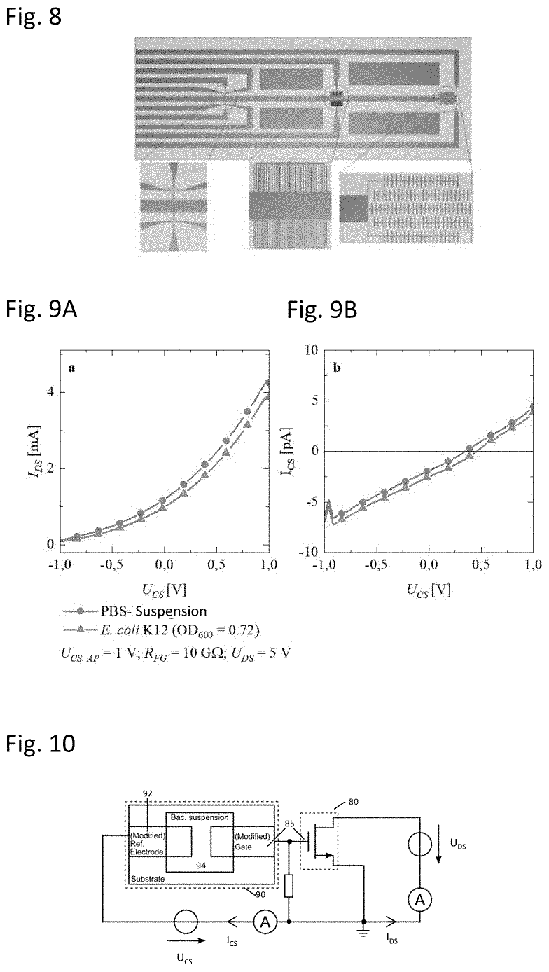

FIG. 8 shows various possible configurations of the dielectrophoretic device 60. The left-hand side dielectrophoretic electrodes 65 are arranged in a point-like manner in which two of the oppositely arranged dielectrophoretic electrodes 65 are at ground and the other two of the oppositely arranged dielectrophoretic electrodes have the AC voltage source 70 connected. The middle and the right-hand side dielectrophoretic electrodes 65 are arranged in different interdigital configurations.

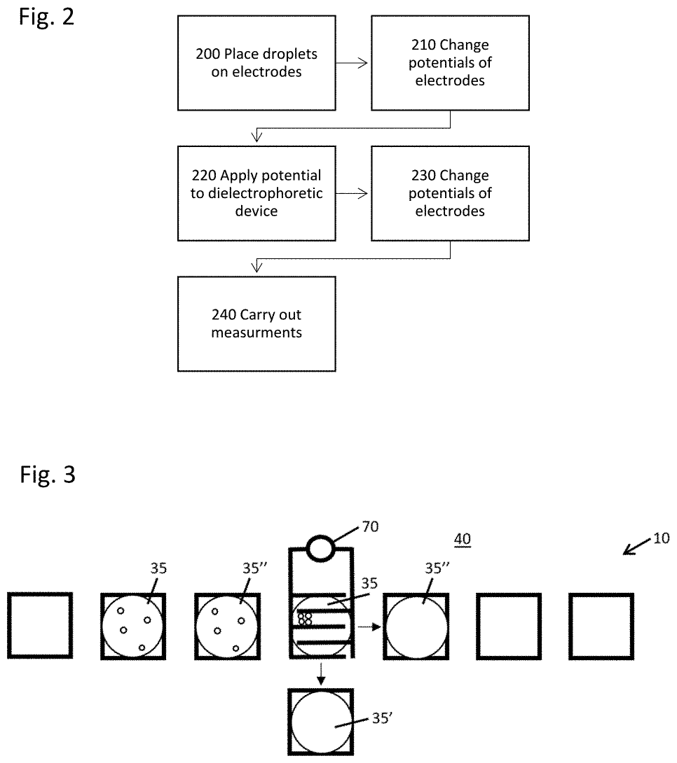

The operation of the sensor system 10 will now be explained with respect to FIG. 2. The fluids 30 are placed in step 200 in the form of droplets 35 on ones of the plurality of electrodes 50 on the surface of the substrate 40. The step 200 of placing can be carried out automatically by using, for example, a dropper. In FIG. 1A three droplets 35 of the fluid 30 are shown placed on the leftmost three of the plurality of electrodes 50. The dielectrophoretic device 60 has no droplet on its surface at this stage and is in this state not switched on, i.e., no voltage is applied from the AC voltage source 70. The rightmost three of the plurality of electrodes 50 have no droplets of the fluids 30 arranged or placed on them. It will be appreciated that the sensor system 10 will generally comprise hundreds of the electrodes 50 and that the sensor system 10 shown in FIGS. 1A-C is a simplification of the sensor system 10.

In a next step 210, the potentials on the plurality of electrodes 50 is changed such that the droplets 35 of the fluid 30 move to the right as is shown in FIG. 1B. One of the droplets 35 of the fluid 30 is then located on the dielectrophoretic device 60 and a potential is applied in step 220 to the interdigital electrodes 65 such that the dielectric particles 20 move towards and are collected at the interdigital electrodes 65, as can be seen in FIG. 1B.

The potentials on the plurality of the electrodes 50 are then changed so that the droplets 35 of the fluid 30 can move in step 230 further to the right, as is shown in FIG. 1C. In this case, the droplet of the fluid 30 on the electrode 50 adjacent to the dielectrophoretic device 60 no longer contains any dielectric particles 20 of biological material. The dielectric particles remain collected at the interdigital electrodes 65.

It will also be seen in FIG. 1C that the dielectric particles 20 from the droplet 35 of the fluid 30 that was previously in FIG. 1B on the adjacent electrode 50 to the left of the dielectrophoretic device 60 have also been moved in step 230 to the dielectrophoretic device 60 and are collected at the interdigital electrodes 65 of the dielectrophoretic device 60.

The method of applying a change to the potential of the plurality of the electrodes 50 and thereby moving the droplets of the fluid 30 continues and more and more dielectric particles 20 of biological material will be collected on the interdigital electrodes 65 of the dielectrophoretic device 60. The dielectric particles 20 are polarized which means that the potential at the interdigital electrodes 65 will change due to the charges of the biological materials.

The simple system shown in FIGS. 1A to 1C assumes that the dielectric particles 20 have only one type of biological material, e.g., a single type of bacteria, unicellular, or other small cellular organisms. The system is, however, selective and a change of the AC voltage or frequency applied by the AC voltage source 70 will lead to different ones of the biological material being collected on the dielectrophoretic device 60. Whereas in FIG. 1C no biological material is shown in the droplet 35 of the fluid 30 on the electrode 50 adjacent on the right-hand side of the dielectrophoretic device 60, it is possible that only one type of polarized biological material is collected at the interdigital electrodes 65 on the dielectrophoretic device 60. The other types of biological material would be moved through the dielectrophoretic device 60 to the right-hand electrode(s) 30.

A further embodiment of the system is shown in FIG. 3. This FIG. 3 resembles FIG. 1B except that the electrode 50 shown below the dielectrophoretic device 60 is attached to a dye station. No potential is applied to the interdigital electrodes 65 and the dielectric particles in the droplet can move with the droplet. Suppose that the droplet 35 of the fluid 30 is moved downwards in the direction of the arrow instead of rightwards in the direction of the right-hand electrodes 50. The droplet 35 of the fluid then moves to the electrode 50 at which the biological particles can be stained by a droplet 35′ containing the dye from the dye station.

After staining, the droplet 35 of the fluid 30 (with the dye from the dye droplet 35′) can then be moved back from the bottom electrode 35 to the dielectrophoretic device 60 and washed by using a wash droplet (35″) from the adjacent electrode on the left of the dielectrophoretic device (which has no biological material in it). The potential is applied to the interdigital electrodes 65 and the stained biological materials are collected at the interdigital electrodes 65. The wash droplet 35″ is passed through the dielectrophoretic device 60 and moves from the dielectrophoretic device 60 to the adjacent electrode on the right of the dielectrophoretic device 60. The wash droplet 35″ removes the redundant dye from the dielectrophoretic device 60 and the washed dielectric particles 20 of biological material remain on the dielectrophoretic device 60.

It is possible to use a second dye to stain the biological material if the electrodes 50 above the dielectrophoretic device 60 are used.

It will be appreciated that the use of the bottom electrode 35 to enable staining of the biological material will also enable reagents in reagent droplets 35′ to be applied to the biological materials in the droplet 35 of the fluid. The reagents are applied instead of the dye.

In a further aspect, the droplet 35 of the fluid 30 does not need to be moved from the dielectrophoretic device 60 to the bottom electrode 50. As long as the reagent has a small electric charge, it would be possible to keep the droplet 35 of fluid 30 with the dielectric particles 20 on the surface of the dielectrophoretic device 60 and move the reagent droplet 35′ over the surface of the dielectrophoretic device 60.

In a further aspect of the system, one of the electrodes 50 or the dielectrophoretic device 60 can be connected to the gate of at least one floating gate field effect transistor 80. This dielectric charge in the biological materials changes the potential of the gate electrode and thus the current through the floating gate field effect transistor 80 (as explained in Minamiki, T., Minami, T., Sasaki, Y., Kurita, R., Osamu, N. I., Wakida, & Tokito, S. (2015), “An Organic Field-effect Transistor with an Extended-gate Electrode Capable of Detecting Human Immunoglobulin A,” Analytical Sciences, 31, 725-728. doi:10.2116/analsci.31.725). The concentration of the dielectric particles on the interdigital electrodes 65 of the dielectrophoretic device 60 can be used to change the potential on the gate of the floating gate field effect transistor 80 and thus enable detection of even small amounts of biological material with dielectric polarization. The floating gate field effect transistors 80 are, for example, organic field effect transistors.

The connection of one of the electrodes 50 or the dielectrophoretic device 60 to the gate of the at least one floating gate field effect transistor 80 enables the electrode 50 to be used as a multifunctional electrode. The electrode 50 can thus be used for sorting/moving droplets 35 of the fluid 30, for collecting the biological material and as well for detection of the biological material with one single electrode 50. It is therefore not necessary to transport the droplets 35 of the fluid 30 from the electrode 50 that is used for sorting/moving the droplets or for collecting biological material to another electrode 50 that is used for detecting biological material.

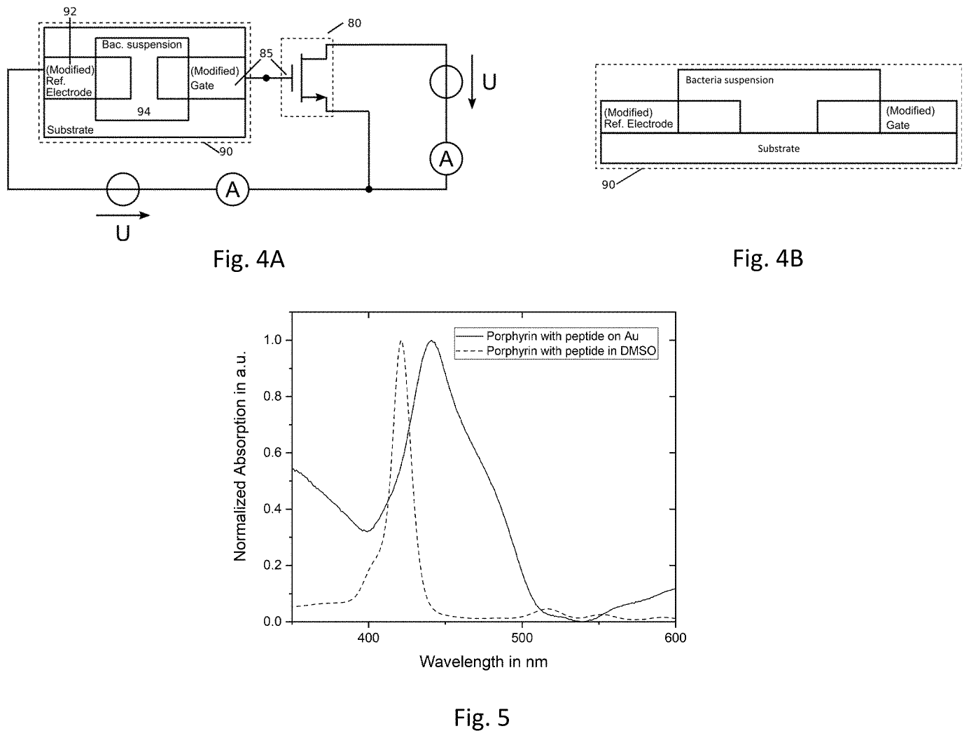

FIGS. 4A and 4B show the construction of the floating gate field effect transistor 80 (FG-FET). The FG-FET can be divided into a sensor unit 90 containing a reference electrode 92, suspension 94 of biological material, and the gate electrode 85 and the field-effect transistor 80 as measuring unit. The sensor unit 90 is physically separated of the FG-FET 80 but electrically connected by the common gate electrode 85 (See Thomas, M. S., White, S. P., Dorfman, K. D., & Frisbie, C. D. (2018, 3), “Interfacial Charge Contributions to Chemical Sensing by Electrolyte-Gated Transistors with Floating Gates,” The Journal of Physical Chemistry Letters, 9, 1335-1339. doi:10.1021/acs.jpclett.8b00285).

On one aspect, the electrodes of the sensor unit 90 are functionalized with modified porphyrins, as explained below, to link bacteria, unicellular, or other small cellular organisms (a biological material) on the electrodes' surfaces. The trapped bacteria, unicellular, or small cellular objects shift the potential at the electrode/suspension interface which, as noted above, affects the voltage on the gate 85 and has an impact on the electrical conductivity of the FG-FET 80 (see Minamiki, T., Minami, T., Sasaki, Y., Kurita, R., Osamu, N. I., Wakida, S.-i., & Tokito, S. (2015), “An Organic Field-effect Transistor with an Extended-gate Electrode Capable of Detecting Human Immunoglobulin A,” Analytical Sciences, 31, 725-728. doi:10.2116/analsci.31.725). The linkage of the bacteria or the unicellular or other small cellular organisms is therefore reflected in changes of the directly measurable current between drain and source electrode of the FG-FET 80.

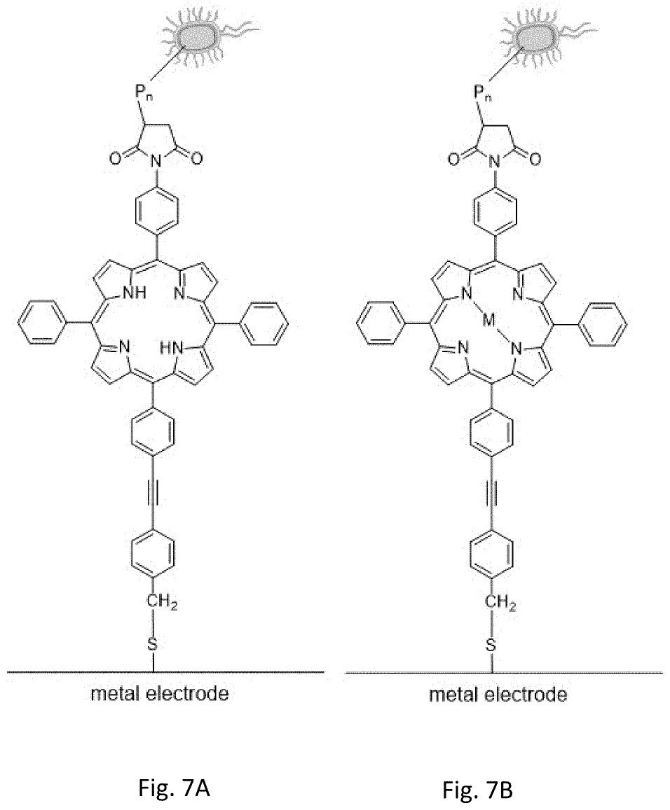

One example of the functionalization of the gate electrode 85 is a porphyrin structure as self-assembled monolayer, as shown in FIGS. 7A and 7B. Originating from a 5,15.diphenyl-porphyrin with a free base (H) (FIG. 7A) or metal center (M) (FIG. 7B), two different linker groups are attached in meso-position within several synthesis steps. One linker has a terminal organic sulfur including group and with an acid removal step of the organic group, the porphyrin can be applied through the sulfur group as a self-assembled monolayer on the metal electrode in an immersion process (see Sathyapalan, A., Lohani, A., Santra, S., Goyal, S., Ravikanth, M., Mukherji, S., & Rao, V. R. (2005), “Preparation, Characterization, and Electrical Properties of a Self-Assembled meso-Pyridyl Porphyrin Monolayer on Gold Surfaces,” Australian Journal of Chemistry, 58, 810. doi:10.1071/ch05176). The second linker at the porphyrin has a terminal maleimide group with the possibility of binding a peptide group (Pn) through the sulfur group in a cysteine amino acid (see Liu, F., Ni, A. S., Lim, Y., Mohanram, H., Bhattacharjya, S., & Xing, B. (2012, 7), “Lipopolysaccharide Neutralizing Peptide-Porphyrin Conjugates for Effective Photoinactivation and Intracellular Imaging of Gram-Negative Bacteria Strains,” Bioconjugate Chemistry, 23, 1639-1647. doi:10.1021/bc300203d). With the peptide functionality it is possible to immobilize bacteria on the metal electrode.

If the dielectric particles 20 (in this case bacteria) are linked through the linkers shown in FIG. 7 to the surface of the gate electrode 85 of the FG-FET 85. the potential between the gate electrode 85 and the suspension 94 shifts. The potential shift becomes measurable due to changes of the current between source and drain electrodes of the FG-FET 85. The gate potential has a distinguished potential according to the bacterial strain or its concentration which enables conclusions from the type of trapped bacteria at the gate electrode 85 solely based on the electrical measured quantities.

In order to only focus on the impact of the modification on the electrical behavior of the FG-FET 85 and to exclude other influences resulting from the potential use of non-standard thin-film devices, a hybrid setup using standard SMD-FETs and a thin-film sensor unit is first created. Different modifications of the functionalized porphyrin were analyzed with different characterization methods as UV/V is spectroscopy, infrared reflection absorption spectroscopy (IRRAS), drop shape analysis (DSA), cyclic voltammetry (CV) and electrochemical impedance spectroscopy (EIS).

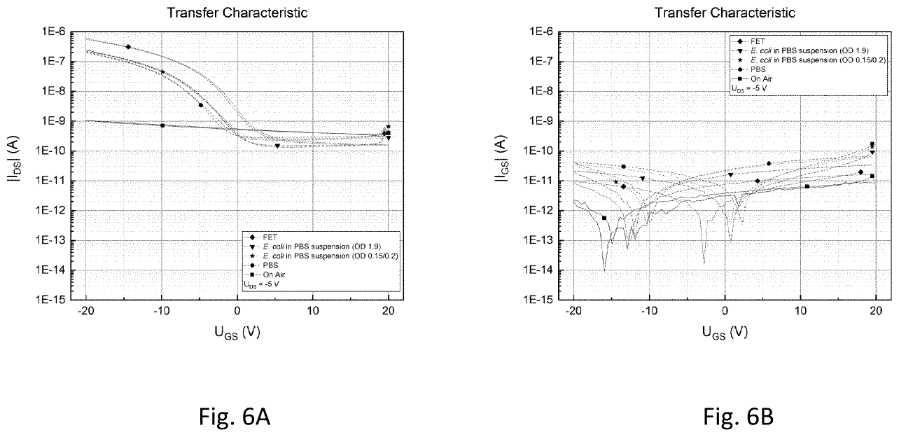

The impact of the functionalized gate electrode 85 on the electrical characteristic of the FG-FET 80 were verified and is visualized in FIG. 6. The transfer characteristics were monitored with two source-measure-units (SMU) B2987A (Keysight Technologies, Santa Rosa, Calif. USA). The devices under test as well as the supply lines were electromagnetic shielded during measurements. Measurements were taken with different suspensions on the sensor unit. First no drop was deposited which led to the results “On Air”. Further phosphate buffer saline (PBS) was deposited without and with E. coli. In the voltage range between −10 V and 0 V a doubling of the current was measured with the bacteria compared to the results without the bacteria.

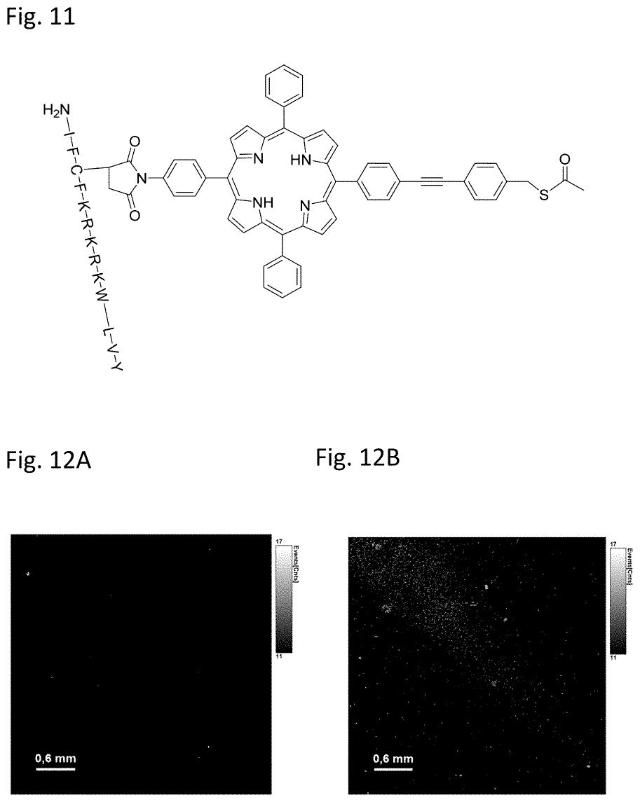

The gate electrode 85 can also be functionalized by the synthesis of the porphyrin structure, as shown in FIG. 11. The enhanced capability of the functionalized surface of the electrode 85 to capture the bacteria can be demonstrated with images derived from images generated using fluorescent lifetime imaging microscopy, as shown in FIG. 12. The left-hand image shows a bacteria-treated and purified gold sample without functionalization. The right-hand image shows a bacteria-treated and purified gold sample with porphyrin as functionalization. The images show an image section of 4 mm×4 mm, with an excitation at λ_{Ex}=375 nm.

The impact of the functionalized gate electrode 85 on the electrical characteristic of the FG-FET 80 were verified using the equivalent circuit according to FIG. 10 and is visualized in FIG. 9. Measurements were taken with different suspensions on the sensor unit. It should be appreciated that a different measurement setup (shown in FIG. 10) was used for the measurements shown in FIGS. 9A and 9B than for the measurements shown in FIGS. 6A and 6B. Further phosphate buffer saline (PBS) was deposited without and with E. coli. Using the measurement setup of FIGS. 9A and 9B, a lower current was measured with the bacteria compared to the results without the bacteria (see FIG. 9A). FIG. 9B shows that the current shown in FIG. 9A is not a leakage-current over the gate.

In a further aspect of the system, the interdigital electrodes 60 are structured to allow patterns of biological material to grow on the surface of the substrate 40. The surface 40 can be cleaned by merely turning off the potential from the voltage source 70.

As noted above, the dielectric particles 20 are biological materials and include, but are not limited to, bacteria, unicellular and other small cellular organisms (e.g., yeasts, and other unicellular fungi).

The movement of the droplets of fluid 30 is dependent on the properties of the surface 40. The surface 40 can have a hydrophobic coating 42, such as but not limited to, parylene, applied to reduce the angle of contact between a surface of the substrate 40 and the droplets of the fluids 30. This enables the droplets of the fluid 30 to move easily between the plurality of the electrodes 30 and the dielectrophoretic device 60.

In a further aspect, the substrate 40 has a structured surface 44 to reduce the area of contact between drops of the fluid 30 and the substrate 40. This reduces the transfer of thermal energy between the droplets of the fluid 30 and the surface 40.

The electrodes 50 in the sensor system are arranged in a matrix-fashion and are independently switchable. The matrix of the electrodes 50 can be programmed as appropriate

### Reference Numerals

10 Sensor system

20 Dielectric particles of biological material

30 Fluid with dielectric particles

35 Droplet

35′ Other fluid droplet

35″ Wash droplet

40 Substrate

42 Hydrophobic coating

44 Structured surface

50 Electrodes

60 Dielectrophoretic device

65 Dielectrophoretic electrodes

70 Voltage source

80 Floating gate field effect transistor

85 Gate

90 Sensor unit

92 Reference electrode

94 Suspension of biological material

1. A sensor system for sensing dielectric particles of biological material in fluids comprising:
a plurality of electrodes arranged on a substrate;
a dielectrophoretic device arranged on the substrate adjacent to one of the plurality of electrodes; and
at least one floating gate field effect transistor arranged on the substrate, wherein the dielectrophoretic device is connected to a gate electrode of the floating gate field effect transistor.

2. The sensor system of claim 1, wherein the dielectrophoretic device is directly connected to the gate electrode of the floating gate field effect transistor.

3. The sensor system of claim 1, wherein the dielectric particles of biological material are bacteria, unicellular or other small cellular objects.

4. The sensor system of claim 1, wherein the substrate has a hydrophobic coating to reduce the angle of contact between a surface of the substrate and drops of the fluids.

5. The sensor system of claim 1, wherein the substrate has a structure surface to reduce the area of contact between drops of the fluid and the substrate.

6. The sensor system of claim 1, wherein the plurality of electrodes are arranged as an active matrix and are independently switchable.

7. A method for sensing dielectric particles of biological material in a fluid droplet using a substrate with a plurality of electrodes, the method comprising:
placing one or more fluid droplets on one of the plurality of electrodes;
applying a potential to ones of the plurality of electrodes to move the one or more fluid droplets with dielectric particles from the ones of the plurality of electrodes to a dielectrophoretic device, the dielectrophoretic device being connected to a gate electrode of a field effect transistor;
applying a potential to the dielectrophoretic device to immobilize and/or sort the dielectric particles on the dielectrophoretic device; and
measuring the current through the channel of the field effect transistor.

8. The method of claim 7, wherein the dielectrophoretic device is directly connected to the gate electrode of the floating gate field effect transistor.

9. The method of claim 7, wherein the dielectric particles of biological material are bacteria, unicellular or other small cellular organisms.

10. The method of any of claim 7, further comprising changing a value or frequency of the potential applied to the dielectrophoretic device to sort different ones of the dielectric particles.
